(19) United States
(12) Patent Application Publication
(10) Pub. No.: US 2024/0001286 A1
(43) Pub. Date: Jan. 4, 2024

(54) DIRECT AIR CAPTURE AND CONCENTRATION OF CO2 USING ADSORBENTS

(71) Applicant: TERRAFIXING INC., Ottawa (CA)

(72) Inventor: Sean Michael Wynn WILSON, Ottawa (CA)

(21) Appl. No.: 18/254,916

(22) PCT Filed: Nov. 26, 2021
(86) PCT No.: PCT/CA2021/051696

§ 371 Date: May 30, 2023

Related U.S. Application Data
(60) Provisional application No. 63/118,926, filed on Nov. 29, 2020.

(51) Int. Cl. B01D 53/047; B01D 53/04

(52) U.S. Cl. CPC B01D 53/0476; B01D 53/0462; B01D 53/0438; B01D 2257/504; B01D 2259/40035

(57) ABSTRACT

This disclosure provides an apparatus and method for capturing CO2 from air, particularly from air having a temperature equal to or less than 0 oC, and/or a humidity less than 5 g of H2O per kg of air, using adsorbents. The apparatus includes an enclosure having an internal volume that contains a CO2 adsorbent bed, and a vacuum source, an input air source, and heater coupled to the enclosure such that the contents, pressure, and temperature of the interior volume of the enclosure can be controlled. Adsorbents for capturing CO2 comprise a zeolite, metal organic framework, covalent organic framework, silica, or alumina. The method provides for flowing input air into an interior volume of an enclosure containing CO2 adsorbent material, heating the CO2 adsorbent material to release the trapped CO2 and collecting it, and re-equilibrating the pressure of the enclosure.

### FIELD OF INVENTION

This application claims the benefit of priority of U.S. Patent Application No. 63/118,926, filed Nov. 29, 2021, the entire contents of which are hereby incorporated by reference.

### FIELD OF INVENTION

The present invention relates to an apparatus and method for capturing CO₂ from air and concentrating it using adsorbents, particularly from source air having low temperature and/or low humidity.

### BACKGROUND OF THE INVENTION

The amount of CO₂ in the atmosphere increases year after year which contributes to the rise of global surface temperatures. Direct air capture and sequestration is one method to reduce the amount of CO₂ in the atmosphere thereby reducing global warming. The importance of direct air capture can be seen from the Intergovernmental Panel on Climate Change's “Special Report on Global Warming of 1.5° C.” which requires carbon negative technologies such as direct air capture in order to meet international climate goals. This has spurred many companies' pursuit of direct air capture technologies such as:
a. Carbon Engineering, which utilizes a KOH absorption unit, as exemplified in Holmes et al. A Process for Capturing CO2 from the Atmosphere. Joule 1-22 (2018);
b. Climeworks, which utilizes amines that are impregnated onto fiber supports, as exemplified in U.S. Pat. No. 10,279,306; or
c. Global Thermostat, which uses amines that are impregnated onto ceramic supports, as exemplified in U.S. Pat. No. 9,908,080.

The problem with current direct air capture technologies is that they are too expensive, with costs surpassing the current U.S. DOE goal of 27-39 $/ton CO₂. Therefore, improvements are required before direct air capture can become an economically viable method for reducing the amount of atmospheric CO₂ for the purpose of greenhouse gas reduction.

CO₂ can be captured from the air anywhere on the planet to reduce net CO₂ emissions. However, from a technological standpoint, the location where direct air capture is carried out is very important for the economic viability of the technology. This is due to the dilute nature of CO₂ in air. In air, 420 ppm of CO₂ occupies only 0.76 g/m3 (at 25° C. and 1 atm) and therefore a substantial amount of air (1,300,000 m3 of air) would be required to capture 1 ton of CO₂. Thus, it is uneconomical to significantly condition the air (that is, change its temperature, humidity, or pressure) when trying to capture the CO₂ and therefore, the CO₂ must be captured from the air at near ambient conditions.

In addition, limitations in the implementation of direct air capture technology occur when the utilized adsorbents are not suitable for use in low-temperature environments, thereby limiting where they can be utilized or requiring further energy input in order to maintain a suitable working temperature.

In addition to temperature limitations of existing direct air capture systems, conventional thinking in the field is that, since there is water in the air, adsorbents that are water unstable or preferentially sorb water over CO₂ are not suitable for use in direct air capture. These adsorbents have therefore been ruled out as viable materials for direct air capture. For example, zeolites are typically hydrophilic and will preferentially adsorb water over CO₂ when exposed to both, therefore they have been determined unsuitable adsorbents for processing ambient air. If materials such as these were to be used, the water content of the air must first be reduced before efficient CO₂ separation can occur. Separating water from air (25° C., 60% humidity) is an energy intensive step and would require roughly six times more energy than separating CO₂ from air using Carbon Engineering's process. This line of thinking has been why sorbents such as zeolites, that are water unstable or preferentially sorb water over CO₂, have been ruled out as potential materials for direct air capture by many experts (see for example, Keith et al, Capturing CO2 from the atmosphere: rationale and process design considerations. Geo-engineering climate change: environmental necessity or Pandora's box. 2010:107-26; Shi et al. Sorbents for the direct capture of CO2 from ambient air. Angewandte Chemie International Edition. 2020 Apr. 27; 59(18):6984-7006).

Based upon these limitations, there exists a need for an apparatus and method for capturing and concentration CO₂ from air for a low energy penalty, to provide a cost-effective manner of removing CO₂ from the air. The novel selection of adsorbents and environmental conditions for implementing the direct air capture process provides for CO₂ capture in an economically viable manner.

### SUMMARY OF THE INVENTION

It is an object of the invention to provide an apparatus and method to capture and concentrate CO₂ from the air in an efficient and cost-effective manner.

According to an aspect of the present invention, there is provided an apparatus to capture CO₂ from the air comprising: an enclosure (having an interior volume), an adsorbent contained within the interior volume of the enclosure, a vacuum pump coupled to the enclosure, a source of input air coupled to the enclosure, and a heater capable of heating the interior volume of the enclosure. The interior volume of the enclosure can be selectively isolated from one or more components of the apparatus to enable selective control of the contents, pressure, and temperature of the interior volume of the enclosure. Prior to entering the enclosure, the input air has a temperature equal to or less than 0° C., and/or humidity of equal to or less than 5 g of H₂O per kg of air.

According to another aspect of the present invention there is provided a method of capturing CO₂ from the air comprising: flowing a source of input air having a temperature equal to or less than 0° C., and/or humidity of equal to or less than 5 g of H₂O per kg of air into an interior volume of an enclosure containing a CO₂ adsorbent material, heating the CO₂ adsorbent material and applying a vacuum source to the interior volume of the enclosure to permit extraction of the CO₂ from within the enclosure, and equilibrating the pressure of the enclosure by permitting an influx of air or gas until the interior volume of the enclosure returns to about atmospheric pressure.

In various aspects the CO₂ capture apparatus further comprises a drying means to dry the input air.

In various aspects the CO₂ adsorbent material comprises a zeolite, metal organic framework, covalent organic framework, silica, or alumina. CO₂ from the air is captured through exposure to the CO₂ adsorbent material, the heating of CO₂ adsorbent material, and subsequent removal of the CO₂ from the interior volume of the enclosure under vacuum.

Aspects of the invention provide various benefits, including that the apparatus and method require low input energy, allowing for the CO₂ to be captured directly from the air at a low cost per given unit. Using input air with low temperature and/or low humidity enables a broad range of CO₂ adsorbent material to be used. The method and apparatus allow for the capture and concentration of CO₂ from the air to be performed in a low cost, cyclical, and continuous manner.

These and other features of the invention will become more apparent from the following description in which reference is made to the appended drawings wherein:

### BRIEF DESCRIPTION OF THE DRAWINGS

The accompanying drawings illustrate embodiments of the invention:

FIG. 1 shows a generalized TVSA cycle for capturing and concentrating CO₂ from ambient air in accordance with an embodiment of the present invention;

FIG. 2 shows further details of the adsorption step from the method of FIG. 1 in accordance with an embodiment of the present invention;

FIG. 3 shows further details of the blowdown step from the method of FIG. 1 in accordance with an embodiment of the present invention;

FIG. 4 shows further details of the evacuation step from the method of FIG. 1 in accordance with an embodiment of the present invention;

FIG. 5 shows further details of the pressurization step from the method of FIG. 1 in accordance with an embodiment of the present invention;

FIG. 6 shows a generalized TVSA cycle for capturing and concentrating CO₂ from ambient air further utilizing a waterbed regeneration step in accordance with an embodiment of the present invention;

FIG. 7 shows further details of the adsorption step from the method of FIG. 6 in accordance with an embodiment of the present invention;

FIG. 8 shows further details of the blowdown step from the method of FIG. 6 in accordance with an embodiment of the present invention;

FIG. 9 shows further details of the evacuation step from the method of FIG. 6 in accordance with an embodiment of the present invention;

FIG. 10 shows further details of the pressurization step from the method of FIG. 6 in accordance with an embodiment of the present invention;

FIG. 11 shows further details of the waterbed regeneration step from the method of FIG. 6 in accordance with an embodiment of the present invention;

FIG. 12 shows the minimum work required to separate all of the CO₂ at a particular feed concentration and concentrate it up to 100% for temperatures of −50° C., −25° C., 0° C., 25° C., and 50° C., in accordance with an embodiment of the present invention;

FIG. 13 shows the effect of temperature on the CO₂ Henry's Law constant of Li—X and Na—X, in accordance with an embodiment of the present invention;

FIG. 14 shows the mean annual molar ratio of CO₂ to H₂O in air;

FIG. 15 shows breakthrough curves of CO₂ during the adsorption step with varied temperatures from 20° C. to −60° C. for Na—X in accordance with an embodiment of the present invention;

FIG. 16 shows the adsorption step temperature's impact on the energies of the method for Na—X in accordance with an embodiment of the present invention;

FIG. 17 shows the additional energy required from a heater for the waterbed regeneration step based on the adsorption step temperature and the relative humidity in accordance with an embodiment of the present invention; and

FIG. 18 shows the total energy required to capture 1 ton of CO₂ using TVSA cycle from FIG. 6 in accordance with an embodiment of the present invention, with Na—X calculated using methodology from the American Physical Society report from mean annual temperature and mean annual humidity data (Socolow et al., Direct Air Capture of CO₂ with Chemicals. American Physical Society—Panel on Public Affairs (2011)).

### DETAILED DESCRIPTION

One or more embodiments of the invention will now be described by way of example. It will be apparent to persons skilled in the art that a number of variations and modifications can be made without departing from the scope of the invention as defined in the claims.

### TVSA Cycle in Accordance With the Invention

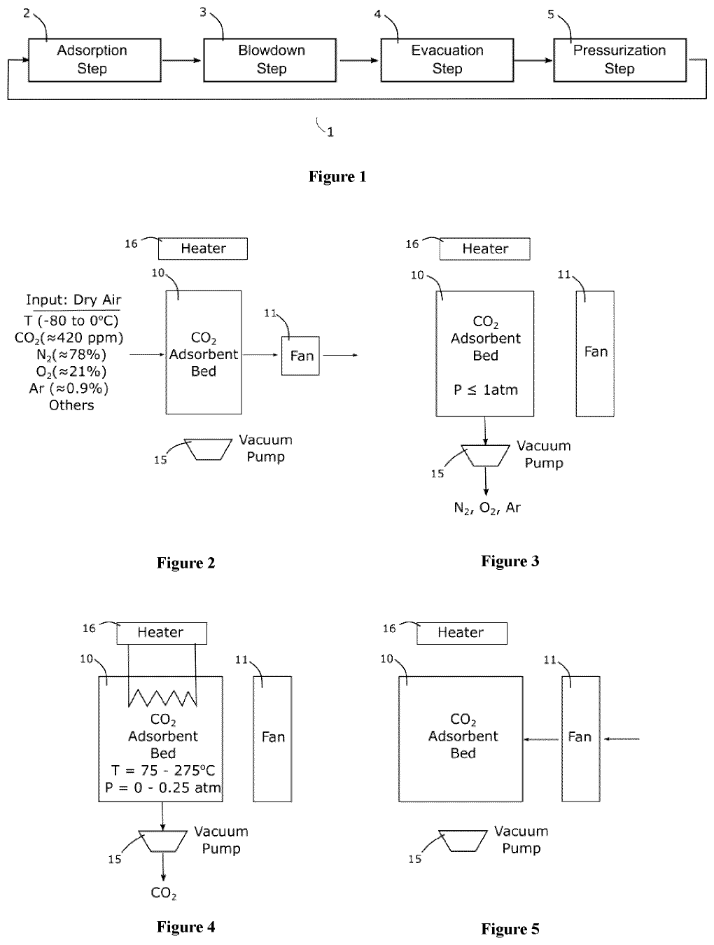

FIG. 1 exemplifies a preferred DAC method to capture atmospheric CO₂ from

ambient air utilizing a temperature vacuum-swing adsorption TVSA cycle (1). This method relies upon dry input air, either from atmospheric conditions or after having been subject to a subsequent drying means such as condensation, crystallization, desiccation, adsorption, membranes, or other absorption method to extract atmospheric water. Input air preferably remains in a dried state below a dew point of −40° C. (at ambient or near ambient conditions), and in a further preferred embodiment remains in a dried state below a dew point(s) of −45° C., −50° C., −55° C., −60° C., −65° C., −70° C., −75° C., or −80° C. (each at ambient or near ambient conditions).

In a preferred embodiment, the TVSA cycle (1) generally comprises the following steps:
a. An adsorption step (2) where the adsorbent is used to capture the approximately 420 ppm of CO₂ from the dry ambient air at near ambient cold conditions between 0° C. and −80° C.;
b. A blowdown step (3) which removes the weakly adsorbed components that are on the adsorbent by applying a vacuum;
c. An evacuation step (4) which desorbs the CO₂ that is on the adsorbent by increasing the temperature and applying a vacuum. The vacuum also removes the CO₂ from the column as a product stream.
d. A pressurization step (5) which pressurizes the adsorbent to adsorption pressures of the adsorption step (2) with dry air;

After the pressurization step (5), the cycle is repeated. By repeating the TVSA cycle (1), further concentration of CO₂ can be achieved from the initial input air.

FIG. 2 exemplifies further details of the adsorption step (2). The adsorption step (2)

flows dry air over the adsorbent in a CO₂ adsorbent bed (10), preferably by using a fan (11) located either upstream or downstream of the CO₂ adsorbent bed (10). This dry input air contains CO₂ concentrations equal to that of atmospheric levels (approximately 420 ppm as of 2021 with CO₂ increasing rapidly year-over-year and being of greater concentration near CO₂ emitting sources). If the input air contains pollutants above acceptable limits (based upon either worker safety or component compatibility), they will need to be removed prior to this step by using materials such as activated carbons or zeolites which do not interact significantly with CO₂.

Dry input air, containing approximately 420 ppm of CO₂, flows over the adsorbent which is located in the CO₂ adsorbent bed (10). The CO₂ is captured via adsorption onto the adsorbent's surface. The air flowing over the adsorbent would be at near ambient conditions of temperature and pressure of the input air. In a preferred embodiment, the input air has a temperature of about 0° C., −1° C., −2° C., −3° C., −4° C., −5° C., −6° C., −7° C., −8° C., −9° C., −10° C., −11° C., −12° C., −13° C., −14° C., −15° C., −16° C., −17° C., −18° C., −19° C., −20° C., −21° C., −22° C. −23° C., −24° C., −25° C., −26° C., −27° C., −28° C., −29° C., −30° C., −31° C., −32° C., −33° C., −34° C., −35° C., −36° C., −37° C., −38° C., −39° C., −40° C., −41° C., −42° C., −43° C., −44° C., −45° C., −46° C., −47° C., −48° C., −49° C., −50° C., −51° C., −52° C., −53° C., −54° C., −55° C., −56° C., −57° C., −58° C., −59° C., −60° C., −61° C., −62° C., −63° C., −64° C., −65° C., −66° C., −67° C., −68° C., −69° C., −70° C., −71° C., −72° C., −73° C., −74° C., −75° C., −76° C., −77° C., −78° C., −79° C., or −80° C., or any range or combination of those temperatures. It is further preferred embodiment, the method takes place in a climate with an annual mean temperature of about 0° C., −1° C., −2° C., −3° C., −4° C., −5° C., −6° C., −7° C., −8° C., −9° C., −10° C., −11° C., −12° C., −13° C., −14° C., −15° C., −16° C., −17° C., −18° C., −19° C., −20° C., −21° C., −22° C. −23° C., −24° C., −25° C., −26° C., −27° C., −28° C., −29° C., −30° C., −31° C., −32° C., −33° C., −34° C., −35° C., −36° C., −37° C., −38° C., −39° C., −40° C., −41° C., −42° C., −43° C., −44° C., −45° C., −46° C., −47° C., −48° C., −49° C., −50° C., −51° C., −52° C., −53° C., −54° C., −55° C., −56° C., −57° C., −58° C., −59° C., −60° C., −61° C., −62° C., −63° C., −64° C., −65° C., −66° C., −67° C., −68° C., −69° C., −70° C., −71° C., −72° C., −73° C., −74° C., −75° C., −76° C., −77° C., −78° C., −79° C., or −80° C. (or any range or combination thereof).

The adsorption step (2) can operate at atmospheric pressures between 30 and 120 kPa, and at CO₂ concentrations between 10 to 10,000 ppm. Air exiting from the CO₂ adsorbent bed (10) would contain significantly less CO₂ than the input air up until the CO₂ adsorbent bed (10) begins to reach its adsorption capacity. The adsorption step (2) proceeds until the adsorbent bed (10) reaches its target adsorption capacity. In a preferred embodiment, target adsorption capacity is measured from a feedback loop measuring the exiting CO₂ concentration from the CO₂ adsorbent bed (10). In another preferred embodiment, the target adsorption capacity is preconfigured via predictive modelling based upon based the adsorbent's characteristics, and the input air's flow rate and temperature.

In a preferred embodiment, the CO₂ adsorbent bed (10) is designed to have a low

pressure drop across the bed (in the direction of air flow), and in a preferred embodiment the pressure drop across the CO₂ adsorbent bed (10) would be below 2000 Pa. In a more preferred embodiment the pressure drop would be below 500 Pa. These low pressure drops can be achieved by using monolithic adsorbent structures, structured adsorbent packing, or packed beds filled with large pellets with the packed bed having a low length over diameter ratios.

In a preferred embodiment, the ratio of the length of the CO₂ adsorbent bed (10) over the diameter of the CO₂ adsorbent bed (10) is less than 10, less than 9, less than 8, less than 7, less than 6, less than 5, less than 4, less than 3, less than 2, or less than 1 for adsorbent pellets between 1 mm and 100 mm in diameter. In a more preferred embodiment, the diameter of the adsorbent pellets is 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm or 25 mm (or any ranger or average of values therein), with length over diameter ratios less than 2, less than 1.9, less than 1.8, less than 1.7, less than 1.6, less than 1.5, less than 1.4, less than 1.3, less than 1.2, less than 1.1, less than 1, less than 0.9, less than 0.8, less than 0.7, less than 0.6, less than 0.5, less than 0.4, less than 0.3, less than 0.2, less than 0.1, and any ranges, combinations, or averages thereof.

The size and scale at which the invention can be carried out can be tailored to best account for the available space and desired throughput of the system. In a preferred embodiment, the CO₂ adsorbent bed (10) is fully contained within a larger enclosure, such as a tank or container, and the remaining steps of the method are carried out by altering the pressure, temperature, or air sources within the enclosure.

In alternative embodiments, the enclosure is comprised of a series of tanks or containers linked together. In a further alternative embodiment, the enclosure containing the adsorbent bed (10) is configured as a cylindrical column or tube (or series of columns or tubes), which optimizes the interaction between the input air and the CO₂ adsorbent material. In a further embodiment, the CO₂ adsorbent bed (10) can be isolated via rotation of a rotating/moving conduit gate valve. In another embodiment, the CO₂ adsorbent bed (10) can be rotated/moved in order to be isolated.

FIG. 3 exemplifies further details of the blowdown step (3), which is initiated once the target adsorption capacity is reached. The blowdown step (3) begins by isolating the CO₂ adsorbent bed (10) from the input air to obtain an air-tight system. In a preferred embodiment, this is achieved by isolating the CO₂ adsorbent bed (10) from the fan (11) and input air source via gates, baffles, valves, or physically moving or rotating the CO₂ adsorbent bed (10) out of the input air stream.

After isolating the CO₂ adsorbent bed (10) from the input air, a vacuum source such as a vacuum pump (15) is connected to the CO₂ adsorbent bed (10). In a preferred embodiment, the vacuum pump (15) is connected to the CO₂ adsorbent bed (10) by a gate, valve, or baffle. The vacuum pump (15) reduces the pressure within the CO₂ adsorbent bed (10) to below ambient pressures. The degree to which the pressure is reduced during this step determines the purity of the final CO₂ product stream. The lower the pressure during the blowdown step (3), the higher the final purity of the CO₂ product stream. In a preferred embodiment, the blowdown step (3) occurs at 0.0000001, 0.000001, 0.00001, 0.0001, 0.001, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, or 1 atm pressure, and any range or combination or average thereof. In a particularly preferred embodiment a high purity CO₂ product stream can be obtained having a CO₂ concentration above 90%, above 91%, above 92%, above 93%, above 94%, above 95%, above 96%, above 97%, above 97.5%, above 98%, above 98.5%, above 99%, above 99.5%, or above 99.9%. In a particularly preferred embodiment, the blowdown step (3) occurs at a pressure between 0-0.1 atm and achieves a CO₂ concentration above 99%.

By reducing the pressure within the CO₂ adsorbent bed (10), the weakly adsorbed components of the input air (predominantly composed of N₂, O₂, and Ar) are removed from the CO₂ adsorbent bed (10) while keeping the bulk of the CO₂ on the adsorbent. In a preferred embodiment, this stream of air, (being rich in N₂, O₂ and Ar), can be stored in a buffer tank for later use.

In an alternative embodiment, where the target concentration of the CO₂ product stream is acceptable without the requirement of removing the N₂, O₂, and Ar, from the CO₂ adsorbent bed (10) using a vacuum, the blowdown step (3) can be omitted and the method proceeds from the adsorption step (2) straight to the evacuation step (4).

FIG. 4 exemplifies further details of the evacuation step (4). The evacuation step (4) desorbs the CO₂ from the adsorbent by heating up and/or applying a further vacuum to the CO₂ adsorbent bed (10). In a preferred embodiment, the evacuation step (4) activates a heater (16), which is configured to warm the CO₂ adsorption bed (10) to a temperature of about 50-55° C., 55-60° C., 60-65° C., 65-70° C., 70-75° C., 75-80° C., 80-85° C., 85-90° C., 90-95° C., 95-100° C., 100-105° C., 105-110° C., 110-115° C., 115-120° C., 120-125° C., 125-130° C., 130-135° C., 135-140° C., 140-145° C., 145-150° C., 150-155° C., 155-160° C., 160-165° C., 165-170° C., 170-175° C., 175-180° C., 180-185° C., 185-190° C., 190-195° C., 195-200° C., 200-205° C., 205-210° C., 210-215° C., 215-220° C., 220-225° C., 225-230° C., 230-235° C., 235-240° C., 240-245° C., 245-250° C., 250-255° C., 255-260° C., 260-265° C., 265-270° C., 270-275° C., 275-280° C., 280-285° C., 285-290° C., 290-295° C., 295-300° C., or any further range, combination, or average thereof.

The heater (16) can apply heat to the CO₂ adsorbent bed (10) via any acceptable electrical, chemical, sensible, radiative, heat exchange, or other generally known heating means, and may heat the inner area of the CO₂ adsorbent bed (10) via an immersion heater or heat exchanger, or alternatively heat the exterior or other portion of the enclosure, and thereby conduct, convey, or radiate heat to the CO₂ adsorbent bed to indirectly heat the CO₂ adsorbent material. In a preferred embodiment, the heater (16) utilizes heat from an alternative source, such as utilizing “waste” heat from a separate source to facilitated CO₂ capture. In a preferred embodiment, the CO₂ adsorbent bed (10) is heated using pressurized CO₂ flowing between the heater (16) and CO₂ adsorbent bed (10). In a particularly preferred embodiment, this heated CO₂ is obtained from previous operation of the TVSA cycle (1).

In a preferred embodiment, a vacuum source is also used to remove the CO₂ from the CO₂ adsorbent bed (10). Once the bed is sufficiently heated, a vacuum pump (15) would be turned on to reduce the pressure within the CO₂ adsorbent bed (10). In a preferred embodiment, the heating of the CO₂ adsorbent bed (10) and the reduction of pressure can occur simultaneously. In a further preferred embodiment, the pressure of the CO₂ adsorbent bed (10) is reduced to between 0 to 0.25 atm, to extract as much of the CO₂ from the CO₂ adsorbent bed (10) as possible. As the evacuation step (4) is occurring, a purified stream of CO₂ exits the vacuum pump (15) and can be collected for further use. This CO₂ stream can be as high as 99.999% pure. In a further embodiment, the CO₂ can be used in a sequestering process, enabling long-term removal of CO₂ from the atmosphere.

FIG. 5 exemplifies further details of the pressurization step (5). In one embodiment, the vacuum pump (15) and the heater (16) would be disconnected from the CO₂ adsorbent bed (10) and the fan (11) would be connected. Dry air would then be fed into the method and used to pressurize the CO₂ adsorbent bed (10) to adsorption pressure of the adsorption step (2) which is at approximately ambient air pressures. In a preferred embodiment, this dry air would come from ambient air that has been dried to a dew point below −40° C., dry air that has been stored from another step of the method, or can be air that is exiting the a parallel method during the adsorption step (2). Once ambient pressures are reached, the cycle is complete and the method can be repeated.

### TVSA Cycle Further Incorporating Desiccation and Filtration in Accordance With the Invention

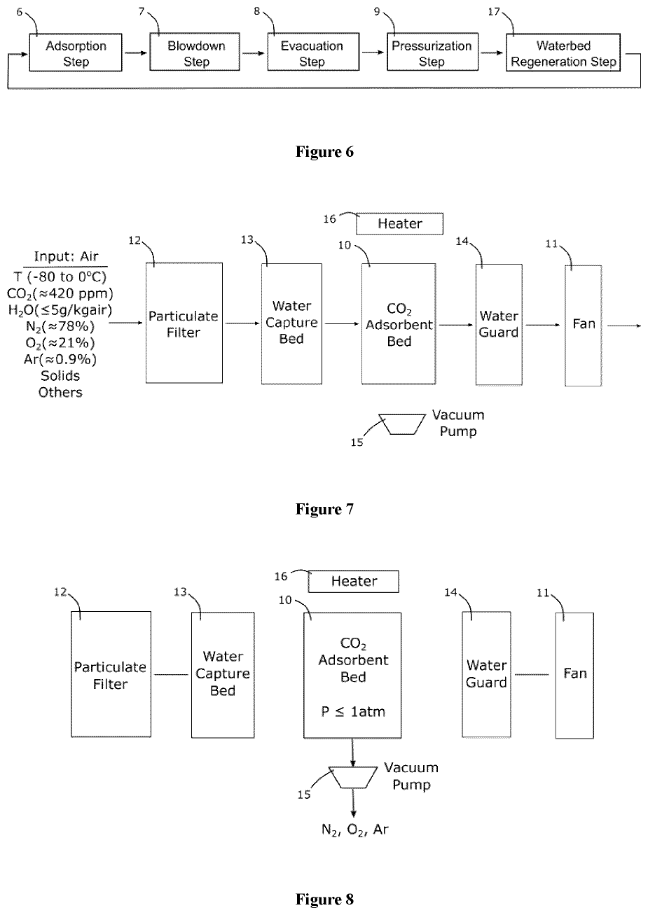

FIG. 6 is an example of a further preferred embodiment of the present invention where the previously described TVSA cycle further comprises a drying means, such as condensation, crystallization, desiccation, adsorption, membranes, or other absorption method to extract atmospheric water from the input air. This method also incorporates heat recovery of the sensible heat (i.e. heat used to heat up the CO₂ adsorbent bed (10)) from the CO₂ adsorbent to help regenerate the desiccant.

In a preferred embodiment, the TVSA cycle with desiccation and filtration generally

comprises the following steps:
a. An adsorption step (6) where the adsorbent is used to capture the approximately 420 ppm of CO₂ from ambient air at near ambient conditions between −80 and 0° C.;
b. A blowdown step (7) which removes the weakly adsorbed components that are on the adsorbent by using the vacuum;
c. An evacuation step (8) which desorbs the CO₂ that is on the adsorbent by increasing the temperature and applying the vacuum. The vacuum also removes the CO₂ from the column as the product stream;
d. A pressurization step (9) where the adsorbent is pressurized to adsorption pressures with dry air; and
e. A waterbed regeneration step (17) where air is flown from the adsorbent to a desiccant to use the sensible heat of the adsorbent to desorb and regenerate the desiccant.

After the waterbed regeneration step (17), the method is repeated with the adsorption step (6). By incorporating the waterbed regeneration step (17), significant energy savings are achieved by decreasing the energy required to regenerate the desiccant.

This TVSA cycle with desiccation and filtration relies upon many of the same principles discussed in respect of the previously-described TVSA cycle. As such, focus of this section will only be placed upon additional elements or particular areas of focus, and reference to the previous discussion of the adsorption, blowdown, evacuation, and pressurization steps of the TVSA cycle (1) are intended to be incorporated herein.

FIG. 7 exemplifies further details of the adsorption step (6) of the TVSA cycle with desiccation and filtration. In a preferred embodiment, the previously described input air has a humidity equal to or less than 5 g_{H2O}/kg_{Air}, about 5-4.5 g_{H2O}/kg_{Air}, about 4.5-4.0 g_{H2O}/kg_{Air}, about 4.0-3.5 g_{H2O}/kg_{Air}, about 3.5-3.0 g_{H2O}/kg_{Air}, about 3.0-2.5 g_{H2O}/kg_{Air}, about 2.5-2.0 g_{H2O}/kg_{Air}, about 2.5-2.0 g_{H2O}/kg_{Air}, about 2.0-1.5 g_{H2O}/kg_{Air}, about 1.5-1.0 g_{H2O}/kg_{Air}, about 1.0-0.5 g_{H2O}/kg_{Air}, or less than 0.5 g_{H2O}/kg_{Air}, along with any ranges, combinations, or averages therein.

Input air passes first through a particulate filter (12) to remove any solids that may be present within the air stream that will accumulate in the system. These solids can be particulate matter, ice crystals, or any other materials that are greater than 1 μm which are airborne and may negatively impact the function of the adsorbent. The filtering of these particulates from the input air can be achieved using a known technology such as grates, electrostatic, or fiber filters. In a preferred embodiment, the filtering is done in-line with the remaining step in the method.

Filtered air is then passed through a water capture bed (13) comprising a desiccant that removes water from the air. This water capture bed (13) can be filled with any of several known desiccants such as silica gel, 3A (a zeolite that is also often described as a molecular sieve), activated carbons, aluminas, or certain metal organic frameworks (MOFs). In a preferred embodiment, the desiccant contained within the water capture bed (13) does not adsorb CO₂ in significant quantities (for example, 0.1 mmol_{CO2}/g_{desiccant}@0° C.) at a partial pressure of 0.0004 atm CO₂ and removes water from the input air at near ambient conditions.

The resulting dried air then flows into the CO₂ adsorbent bed (10) in a similar way to

the previously described adsorption step (2) from FIG. 2. In a preferred embodiment, a secondary desiccant located in a water guard (14) (of the same or different type used in the water capture bed (13)) is also located downstream from the CO₂ adsorbent bed (10), to ensure that water is equally removed from any air entering the CO₂ adsorbent bed (10) during the pressurization step (9).

FIG. 8 exemplifies further details of the blowdown step (7), which occurs once the CO₂ adsorbent bed (10) reaches the target adsorption capacity, in the same manner as described previously (see discussion of FIG. 3). The isolation of the CO₂ adsorbent bed (10) described in FIG. 3 equally isolates the CO₂ adsorbent bed (10) form the water capture bed (13) and water guard (14) in this embodiment, through the same available isolation means.

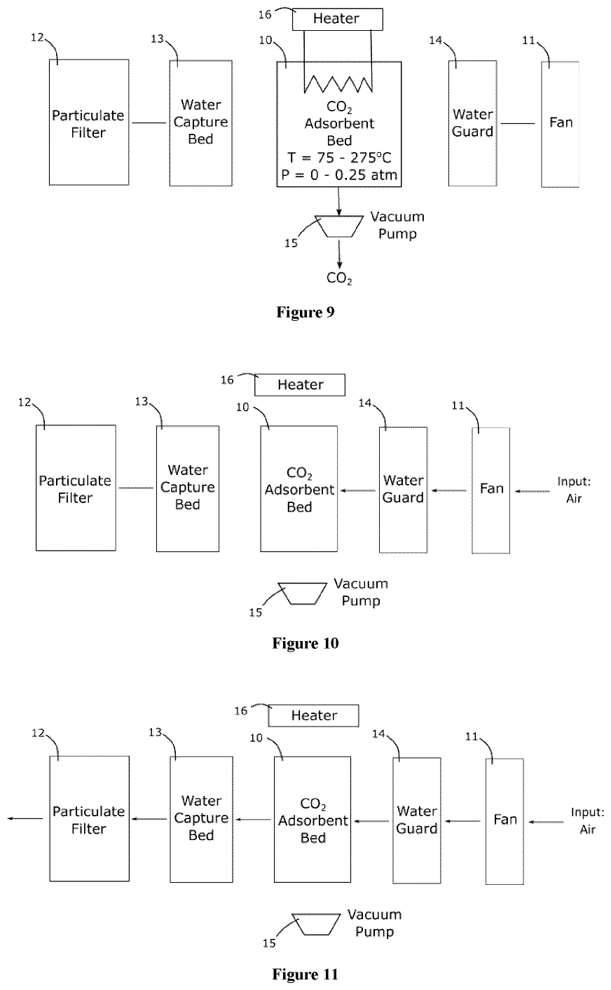

FIG. 9 exemplifies further details of the evacuation step (8), in the same manner as previously described (see discussion of FIG. 4).

FIGS. 10 and 11 exemplify further details of the pressurization step (9) and waterbed regeneration step (17). The vacuum pump (15) is disconnected from the CO₂ adsorbent bed (10), and the pressure of the CO₂ adsorbent bed (10) is returned to atmospheric pressure by adding a source of pressurization air. In one embodiment, this pressurization air can be the same input air used in the adsorption step (6). In another embodiment, this pressurization input air differs from the input air used in the adsorption step (6), and in a preferred embodiment the pressurization air is obtained from an air source collected from a previous step of the method, or from exhaust air from the adsorption step (6) of another method being performed in parallel. In this preferred embodiment, this pressurization air contains a limited or reduced amount of water to minimize the required size of the water guard (14). In such a preferred embodiment, the input air enters the CO₂ adsorbent bed (10) by passing first through the water guard (14), which acts to remove any remaining water from this pressurization air in a similar manner to the water capture bed (13). The pressurization air then passes through the CO₂ adsorbent bed (10) at low speed to enable it to absorb heat from the CO₂ adsorbent. This heated air then passes through the water capture bed (13) to exit the enclosure. In a particularly preferred embodiment, this exiting air also exhausts through the particulate filter (12).

In a preferred embodiment, this reverse flow of air for the pressurization step (9) and waterbed regeneration step (17) acts to ensure the apparatus is regenerated between cycles, while ensuring water is not able to enter the CO₂ adsorbent bed (10). This permits the method to be cycled with minimal downtime and at reduced energy cost. During the evacuation step (8), the CO₂ adsorbent bed (10) is heated to desorb the CO₂. Much of this heat is retained by the CO₂ adsorbent bed (10) (i.e. as sensible heat), and needs to be cooled before the method can be repeated. During the pressurization step (9) and the waterbed regeneration step (17), dry air flows into the CO₂ adsorbent bed (10) at a slow rate so that it can be heated by this sensible heat of the CO₂ adsorbent bed (10). This heated dry air can then be exhausted through the water capture bed (13). The desiccant is regenerated using the heat from this warm air. In appropriate circumstances, the heater (16) or an additional heater (not shown) can be operated during the waterbed regeneration step (17) to ensure that a sufficient supply of warm air is available to regenerate the water capture bed (13).

In another preferred embodiment, once the water capture bed (13) has been regenerated, the flow of air can be reversed and air from inside the CO₂ adsorbent bed (10) can be allowed to exhaust through the water guard (14), acting to regenerate the water guard (14) for future use. In an alternative embodiment, the regeneration can be aided by the heater (16) or an additional heater placed (not shown) configured so as to further heat the flow of air between the water guard (14) and the CO₂ capture bed (10).

In a preferred embodiment, care is taken to ensure that no water is in the input air for

the pressurization step (9) and waterbed regeneration step (17) by using dried air that has been stored from another step in the method or the exhaust air from the adsorption step (6) of a parallel method. By taking care to ensure no water is in the input air, the water guard (14) can be omitted from the design as no water is required to be removed prior to input air being fed into the CO₂ capture bed (10).

In a preferred embodiment, the alternative flow of air through the various cycles is controlled by the fan (11), which in a particularly preferred embodiment is located at the most downstream portion of the system relative to the input air used in the adsorption step (6).

Under either method described above, modifications can be made to the implementation of the invention. For example, in a preferred embodiment there are multiple machines performing the method simultaneously, but at offset steps, such that dry air from the first method can be immediately used as input air in the second method. Alternatively, the steps need not be directly linked, such that the various steps are operated only during their most optimal time, such as overnight for the adsorption step (2 or 6) when cold temperatures are most desired, which is then held until the day when temperatures have increased to perform the heating steps of the evacuation step (4 or 8) when higher temperatures are desired. This would be expected to provide a further reduction in the cost per ton to capture and concentrate CO₂, balanced only against the desired throughput.

In preferred embodiments, the methods described above are carried out in facilities located at, or in close proximity to, clean energy sources such as wind, solar, hydro, geothermal, nuclear energy generating stations, or other clean energy sources. Other than powering this method to capture and concentrate CO₂, this method would enable otherwise excess “waste” energy not needed by the power grid (during times of low power usage) to be utilized in CO₂ capture.

In alternatively preferred embodiments, the methods described above are carried out in connection with facilities that generate a suitable supply of input air, or are able to utilize the produced concentrated CO₂ or other concentrated gasses obtained during the blowdown step (3 or 7) or evacuation step (4 or 8).

### Preferred Materials and Environmental Conditions For Use With the Invention

Materials that preferentially sorb water over CO₂ have been used air pre-purification processes since the early 1980s. Air pre-purification units would utilize faujasite structured zeolites such as Na—X to capture CO₂ from the air to reduce its concentration to less than the ppm level. Such methods work by first pressurizing the ambient air to high pressures (e.g. 50-150 psia) which serves to separate the water, then feeding the pressurized gas into an adsorbent bed for the removal of trace amounts of water and CO₂. This dry air, free of CO₂, is then fed into another unit for the production of N₂ or O₂. However, these materials have not been used for the capture and concentration of CO₂, and had been deemed unsuitable due to their low affinity for CO₂ in comparison to water.

However a wide variety of adsorbents, including those previous deemed unsuitable for use in the capture and concentration of CO₂, are suitable for use in accordance with this invention. In a preferred embodiment, the adsorbent chosen for the CO₂ adsorbent bed (10) should have at least an adsorption capacity for CO₂ greater than 0.1, greater than 0.2, greater than 0.3, greater than 0.4, greater than 0.5, greater than 0.6, greater than 0.7, greater than 0.8, greater than 0.9, greater than 1.0, greater than 1.1, greater than 1.2, greater than 1.3, greater than 1.4, greater than 1.5, greater than 1.6, greater than 1.7, greater than 1.8, greater than 1.9, greater than 2.0, greater than 2.1, greater than 2.2, greater than 2.3, greater than 2.4, greater than 2.5, greater than 2.6, greater than 2.7, greater than 2.8, greater than 2.9, greater than 3.0, greater than 3.1, greater than 3.2, greater than 3.3, greater than 3.4, greater than 3.5, greater than 3.6, greater than 3.7, greater than 3.8, greater than 3.9, greater than 4.0, greater than 4.1, greater than 4.2, greater than 4.3, greater than 4.4, greater than 4.5, greater than 4.6, greater than 4.7, greater than 4.8, greater than 4.9, greater than 5.0 mmolCO₂/g adsorbent at conditions of 0° C. and partial pressures of 0.0004 atm of CO₂, including ranges, combinations, and averages thereof.

In another preferred embodiment the preferred CO₂ adsorbent has a surface area greater than 100 m²/g. In a further preferred embodiment, the CO₂ adsorbent has a pore structure that allows CO₂ to diffuse through its structure at temperatures below 0° C.

In another preferred embodiment the adsorbent has an average heat of adsorption of CO₂ less than 100 kJ/mol, less than 95 kJ/mol, less than 90 kJ/mol, less than 85 kJ/mol, less than 80 kJ/mol, less than 75 kJ/mol, less than 70 kJ/mol, less than 65 kJ/mol, less than 60 kJ/mol, less than 55 kJ/mol, less than 50 kJ/mol, less than 45 kJ/mol, less than 40 kJ/mol, less than 35 kJ/mol, less than 30 kJ/mol, or less than 25 kJ/mol, including any ranges, combinations, or averages thereof.

The heat of adsorption is important with regards to the energy required to desorb the CO₂ with larger heats of adsorption requiring more energy for desorption of the CO₂. The profile of the heat of adsorption with respects to loading, which can be seen in a Clausius-Clapeyron relationship, is also important. This relationship shows that the initial CO₂ that is adsorbed releases more energy than subsequent CO₂ adsorbed. Thus, the initial CO₂ adsorbed would require more energy to desorb than subsequently adsorbed CO₂ molecules. In a particularly preferred embodiment, the heat of adsorption of CO₂ on the adsorbent would be as low as possible and constant over a range of loadings.

One beneficial aspect of the invention is that adsorbents that are commonly considered to be water unstable, or otherwise preferentially adsorb water over CO₂, can be used to capture and concentrate CO₂ due to the water removal prior to the separation of CO₂. This allows many adsorbents, such as aluminas, zeolites, covalent organic frameworks (COF), and MOFs, to be used for DAC, contrary to accepted practices.

In a preferred embodiment, the CO₂ adsorbent bed (10) is made up of zeolites having oxygen tetrahedral frameworks incorporating Si, Al, P, Ge, B, Mg, Zn, Ga, Co, or Be, (including the presence of two or more differing structures, or mixtures of different structures). In an alternatively preferred embodiment, the CO₂ adsorbent bed (10) is made up of mixtures of CO₂ adsorbent materials having non-framework species, or mixtures of framework and non-framework species.

In a further preferred embodiment, the zeolite frameworks include, but are not limited to, Linde Type A, faujasite, or chabazite, which all have large CO₂ adsorption capacities at low CO₂ partial pressures but adsorb water competitively over CO₂. Faujasite structured zeolites, and in particular faujasite structured zeolites with a Si/Al ratio of below 2, are particularly preferable adsorbents for this separation.

Preferred zeolites can have a variety of counterbalancing cations in the metals group within them, such as alkali or alkaline earth metals, which change the strength of interaction with CO₂ and therefore, the heat of adsorption of CO₂. In a preferred embodiment, MOF's including, but not limited to, NbOFFIVE-1-Ni, SGU-29, Mg-MOF-74, SIFSIX-3-Cu, SIFSIX-2-Cu, Mg-dobpdc-mmen are also preferred adsorbents for this separation.

In a preferred embodiment, the CO₂ adsorbent bed (10) can be composed of one or more types of adsorbents. In a further preferred embodiment, the adsorbents can be arranged to according to the flow of input air to first expose the air to adsorbent with a weaker CO₂ interaction, then an adsorbent with a stronger CO₂ interaction. In a further preferred embodiment, the same adsorbent in two configurations can be layered according to the direction of the flow. These two configurations can be a pellet/structure/packing with a higher pellet/structure/packing diffusion resistance, and a lower pellet/structure/packing diffusion resistance. These would be oriented with regard to the flow of air as to first have the higher pellet/structure/packing diffusion resistance, and then the lower pellet/structure/packing diffusion resistance

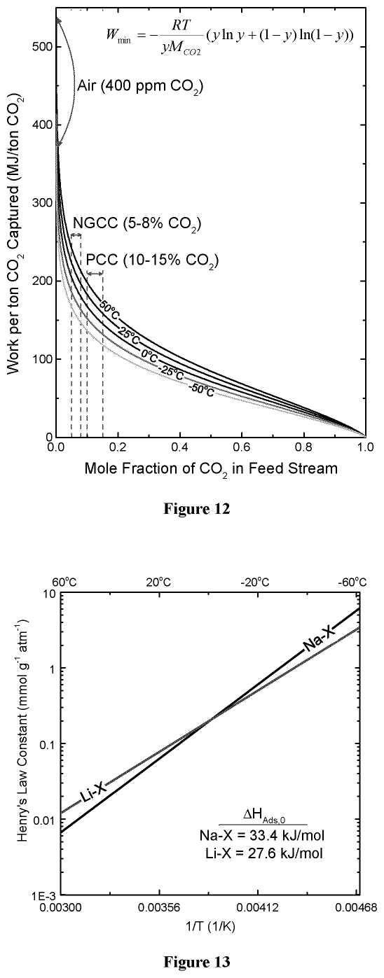

Another benefit of the invention is that it is can be designed to operate at low temperatures that favour separation, due to the amount of work to separate and concentrate CO₂ operating as a function of the temperature at which the separation occurs. Specifically, the lower the system temperature of the invention, the lower the expected energy required to capture CO₂ in accordance with the invention. Though not intended to be limited by any particular scientific principle, this phenomenon is believed to be governed by the second law of thermodynamics, and illustrated in FIG. 12 in which energy requirements are 45% greater at 50° C. than at −50° C. Specifically, for the DAC of CO₂ at 400 ppm, a separation method occurring at 50° C. theoretically has a minimum energy of separation of 538 MJ/ton CO₂ whereas an operating temperature of −50° C. would lower this value to 371 MJ/ton CO₂. Thus, it is preferrable to perform the invention at low temperatures to optimize efficiency.

In a low temperature embodiment, the synergistic effects between the adsorption step (2 or 6) occurring at ambient temperatures below 0° C., and the adsorbents are highlighted leading to lower overall energy requirements for the method. This is due to the adsorbents' CO₂ adsorption capacity being greater at colder temperatures. This can be seen in FIG. 13, which depicts the effect of temperature on the CO₂ Henry's Law constant of Li—X and Na—X, two types of low Si/Al ratio faujasite structured zeolites and particularly preferred adsorbents for use in the invention.

At colder temperatures, the Henry's Law constant for CO₂ is significantly higher than that of warmer temperatures (Li—X, 3.35 mmol/gatm@−60° C., 0.012 mmol/gatm@60° C.). This phenomenon is beneficial for the invention because more CO₂ is adsorbed on the adsorbent per cycle thereby reducing sensible energy losses, leading to overall lower energy demands for the method. FIG. 12 also shows that the effect of temperature is more prominent for Na—X than Li—X, as the heat of adsorption of Na—X is greater than that of Li—X. This demonstrates that a particularly preferred cation for the adsorbent can be optimized depending upon the operating temperature, the adsorbents strength of interaction with CO₂, as well as other factors such as saturation capacity.

Another benefit of the invention in such an embodiment is that, due to the use of cold (i.e. below 0° C.) input air, less water needs to be separated prior to capturing and concentrating CO₂, thereby lowering the total energy requirements of the method. Since separating water requires a significant amount of energy, a particularly preferred embodiment of the invention utilizes a dry input air source, such as air from drier locations or air dried from an alternative means as a “waste” product.

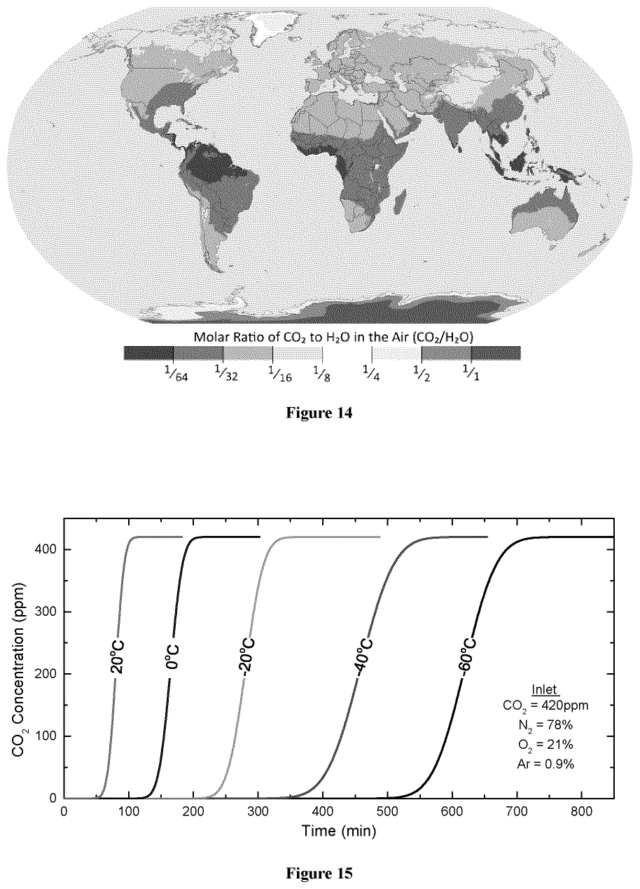

FIG. 14 depicts a schematic of the mean annual molar ratio of CO₂ over H₂O in the ambient air of regions across the globe. For tropical locations such as the Amazon rain forest or the jungles of Indonesia, there is more than 64 parts of H₂O that should be separated to capture one part of CO₂. However, in colder climates, the maximum absolute humidity is less than that of warmer climates, thus, less water needs to be separated per part of CO₂ sequestered. This is most apparent in the Antarctic where the majority of the continent contains less than 1 part H₂O for every part of CO₂. These colder climates, which have an annual mean air temperature between −80° C. and 0° C., are therefore preferable locations to carry out the invention. In an alternative embodiment, input air would be selected from “waste air” (such as an exhaust stream from an unrelated production system) chosen to replicate the naturally occurring air in these preferred climates and provide dry air without the need for additional energy expenditure.

In an alternative embodiment, the invention can utilize air with temperatures above 0° C., provided it contains a very low water content and otherwise behave in an equivalent manner. For example, the Atacama Desert, the Tibetan Plateau, and the Gobi Desert are known for being some of the driest places on the planet, and despite having an annual mean temperature between 0° C. and 20° C., and an annual mean absolute humidity between 0 and 5 g H₂O/kg Air, would be particularly preferable input air source for the invention due to the low amount of water that must be separated before capturing CO₂.

Adsorbents that co-adsorb both water and CO₂ or preferentially adsorb CO₂ also have similar synergisms with cold conditions as mentioned above. Separations are more favorable in cold conditions, the adsorbents perform better in the cold conditions, and they adsorb less water in comparison to CO₂ in cold conditions. These three synergisms increase the performance of these adsorbents except that the air does not need to be dried before entering into the method. If appropriately cold and/or dried air is utilized in the invention, the air does not need to be dried before entering the method for the adsorption step (2 or 6), pressurization step (5 or 9), or waterbed regeneration step (17).

### Example of CO₂ Capture Using the Invention

The embodiment exemplified by FIGS. 6 to 11 was modeled to highlight the advantages of this method, such as the lower energy requirements over other DAC technologies using the same methodology as the American Physical Society (Socolow et al. Direct Air Capture of CO₂ with Chemicals. American Physical Society—Panel on Public Affairs (2011)).

Na—X, a low Si/Al ratio faujasite structured zeolite with Na+ as a cation, was used as the adsorbent in the CO₂ adsorbent bed (10). Modelling used the following properties of Na—X, obtained either from Na—X analysis or otherwise accepted values: C_{ps,0} of 800 J/kg K, kₛ of 0.147 W/m K, rₚₒᵣₑ of 0.0000001 cm, τ of 5, ρ_{S} of 1826 kg/m³, εₚₑₗₗₑₜ of 0.38, ρ_{P} of 1132 kg/m³, ε_{bed} of 0.38, ρ_{B} of 778 kg/m³, and average H_{ads} of 45 kJ/mol.

Silica gel was selected as the desiccant for use in the water capture bed (13), modelled using the following properties (as measured or taken from accepted values): C_{ps,0} of 870 J/kg K, kₛ of 0.151 W/m K, ρ_{S} of 1240 kg/m³, ε_{sorbent} of 0.348, ρ_{B} of 720 kg/m³, and H_{ads} of 2980 kJ/kg.

This example assumes no solids or other contaminant that would affect the adsorbent are entering the method. Dry air from a parallel method is used in the pressurization step (9) of the TVSA cycle as well as for the waterbed regeneration step (17), and therefore, no water guard (14) is required for the exemplified method.

To model the interaction between the ambient air and the adsorbent during the adsorption step (6) of the method, the Rosen model and TD-Toth model were used and were validated experimentally. These experiments allowed for the quantification of the capture fractions and adsorption capacities at 95% inlet concentration within the model.

From the results of the Rosen Model, FIG. 15 is a graph showing exiting concentrations of a column (which would be the CO₂ adsorbent bed (10)), also known as breakthrough curves of CO₂, during the adsorption step (6) at temperatures between 20° C. and −60° C. for 9.5 g of Na—X and an air flow rate of 2.5 standard L/min at 420 ppm CO₂. As the temperature cools, the adsorption capacity increases, thereby increasing the duration before the CO₂ begins to break through the column, for a set amount of adsorbent. These different breakthrough curves highlight the invention's synergistic effects between the adsorption step (6) operating at ambient temperatures below 0° C., and the characteristics of the adsorbents, leading to lower overall energy requirements for the method.

This synergism can be seen from FIG. 15, and the adsorption capacity of the different breakthrough curves was calculated. At 20° C. the adsorption capacity for CO₂ is 0.30 mmol/g. By cooling the temperature to 0° C., −20° C., −40° C., and −60° C., the adsorption capacity increases to 0.64 mmol/g, 1.1 mmol/g, 1.9 mmol/g, and 2.5 mmol/g, respectively. This increase in adsorption capacity reduces the operational energy requirements of the method because the amount of sensible energy required to heat up the adsorbent each cycle is effectively reduced. This also reduces the amount of N₂, O₂, and Ar required to be vacuumed during the blowdown step (7) and increases the adsorption capture fraction decreasing the energy required for flow. The increase in adsorption capacity also lowers the capital cost of the method because less adsorbent is required per ton of CO₂ captured per cycle.

This fast uptake rate can be seen in FIG. 15, with sharp uptake rates even at the coldest modelled conditions of −60° C. Zeolites are particularly good for fast uptakes because the CO₂ does not have to travel all the way into the pellet through the crystal, rather, it can diffuse between the crystals within the pellet. This sharp breakthrough at cold conditions allows for a greater fraction of CO₂ to be captured from the air that goes through the column, thereby decreasing the amount of energy required.

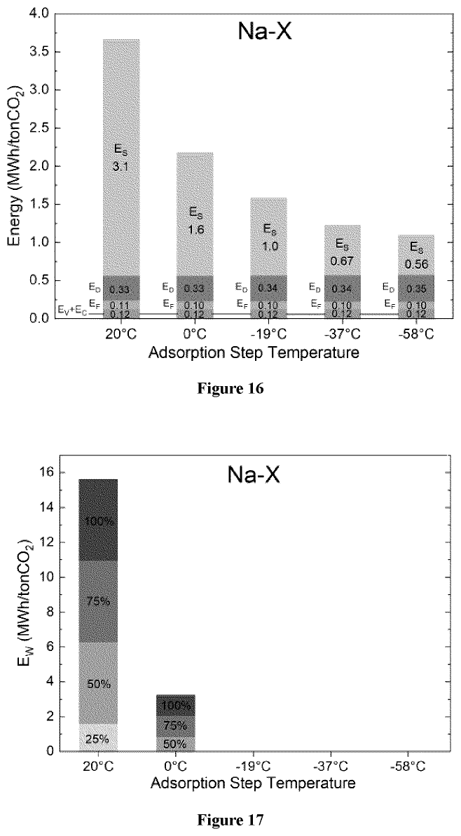

The energy required to capture 1 ton of CO₂ using the TVSA cycle from FIG. 6 with Na—X was calculated and is displayed in FIG. 16. FIG. 16 excludes the additional energy from the heater during the waterbed regeneration step (17). FIG. 16 shows the energy required to heat up the sorbent (E_S), energy for desorption (E_D), energy for flow (E_F), and energy for vacuum and compression (E_V+E_C). For the evacuation step (8), a desorption temperature of 200° C. was required for Na—X. This model assumes that there is 420 ppm of CO₂ in the ambient air. For the energy required, it is assumed that 22.4 MJ/ton CO₂ and 417 MJ/ton CO₂ of energy is required for the vacuum and for the compression of the CO₂ purified stream, respectively. This includes the efficiency of the compressor and vacuum pump of 80%. The pressure drop across the CO₂ adsorbent bed (10) was fixed at 213 Pa with a fan efficiency of 85%. FIG. 16 shows the synergism of cold climates with Na—X for the method with colder temperatures for the adsorption step (6) reducing the energy required for the method. Colder adsorption step temperatures mainly reduce the energy required for heating up the sorbent. This effect is significant with −58° C. requiring less than a third the energy of 20° C. Colder temperature also reduces the energy required for vacuum because more CO₂ per volume is contained in the CO₂ adsorbent bed (10). Colder temperatures also reduce the energy required for flow by increasing the capture fraction of CO₂ for a fixed amount of adsorbent and flow.

The additional energy required to desiccate the air (E_W) to capture 1 ton of CO₂ using the TVSA cycle from FIG. 6 with Na—X was calculated and is displayed in FIG. 17. This was calculated from results from FIG. 16 by subtracting the total energy required to desiccate the air (E_(W,T)) from E_S. E_(W,T) was calculated from the energy required to desorb the H₂O from the desiccant calculated from using the total amount of air that entered the method during the adsorption step (6) and a heat of adsorption of 2980 kJ/kg for silica gel. For the waterbed regeneration step (17), a desorption temperature of 110° C. was required for the silica gel. The total amount of energy for the method is the summation of E_S, E_D, E_F, E_V, E_C, and E_W. For 20° C. above 50% humidity, E_W is greater than all other energies for the TVSA cycle combined (E_S, E_D, E_F, E_V, and E_C). However, as the adsorption step (6) temperature decreases, E_W decreases to the point where no additional energy is required to regenerate the desiccant. This is due to E_W being smaller than E_S below 0° C. and 25% humidity, and highlights the benefits of the waterbed regeneration step (17) in this TVSA cycle. Drier conditions are also beneficial for the method. This can be seen with the total amount of energy for the method for at 20° C. and 25% humidity of 5.2 MWh/ton CO₂ being lesser than 0° C. and 100% humidity of 5.4 MWh/ton CO₂, despite the warmer temperature.

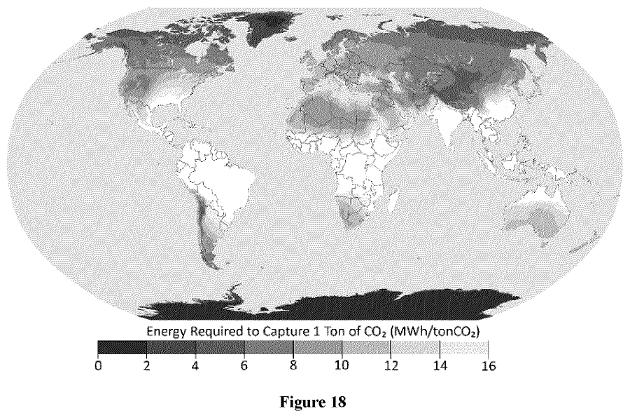

To show the benefit of cold and dry conditions for FIG. 6, a map depicting the energy required to capture, and concentrate CO₂ to 15 MPa using Na—X is shown in FIG. 18. Annual mean temperature and annual mean absolute humidity data were used to approximate the ambient air conditions for a given location, and identify particularly preferable locations to carry out the invention using ambient air. However, the potential for the method to run during particular times of the year or at particular times of the day, when conditions are most favourable to minimize energy requirements, is also possible.

The map from FIG. 18 shows the wide variation in operating energies required to capture 1 ton of CO₂ depending on the location of this method (based upon the location's annual mean ambient temperature, annual mean absolute humidity, and therefore the average conditions of the input air). The maximum energy required to capture 1 ton of CO₂ in locations along the equator, such as the Amazon Rain Forest and the jungles of Indonesia, would require 32.25 MWh/ton CO₂. These locations are the warmest and most humid location on Earth and therefore provide limited efficiency for the invention. However, the coldest and driest location on Earth, Antarctica, requires the least amount of energy for CO₂ capture, being only 1.1 MWh/ton CO₂. In other words, 1.1 MWh/ton CO₂ is the lowest reported energy requirement to capture 1 ton of CO₂ from air using DAC.

These locations provide examples to highlight the beneficial properties of the invention when operated using a cold input air source. To the extent an air source can be obtained in a cool state as a by-product from another operation (and not cooled specifically for CO₂ capture), these beneficial properties could be similarly achieved.

Similarly, given the input variables of temperature and humidity are relevant to efficiency, areas such as the Atacama Desert, the Tibetan Plateau, and the Gobi Desert, which are known for being some of the driest places on the planet, would equally allow for beneficial implementation of the invention. Due to very low humidity in these locations, this method would be expected to require less than 6 MWh/ton CO₂ of energy to operate.

Combining this method along with an inexpensive renewable energy source would allow for this method to be a viable solution for global warming because it would reduce the amount of CO₂, a known greenhouse gas, within the atmosphere. Using wind power from a location such as Antarctica, known to be the windiest location on Earth, would allow for a cheap renewable energy source to run this method, further reducing the cost per ton of CO₂ captured via this method. Assuming that wind energy can be produced at $6/MWh, which is the least expensive wind PPA in 2018 in the USA, operating costs to run this method can be as low as $6/ton CO₂ which is significantly lower than DOE targets for CO₂ capture and sequestration.

All references and publication referred to herein are hereby incorporated by reference in their entirety.

While I believe that the theories that I have presented give benefits to this method, I do not wish to be bound by any particular theory relating to how the invention works, nor should any calculation be taken as exactly true in all circumstances.

Certain currently preferred embodiments have been described by way of example. It will be apparent to persons skilled in the art that a number of variations and modifications can be made without departing from the scope of the claims.

1. An CO₂ direct air capture apparatus, comprising:
a. an enclosure defining an interior volume;
b. a CO₂ adsorbent bed contained within the interior volume of the enclosure;
c. a vacuum source coupled to the enclosure;
d. a source of input air coupled to the enclosure; and
e. a heater capable of heating the interior volume of the enclosure;
wherein the interior volume of the enclosure is configured to be selectively isolated from one or more components of the apparatus to enable selective control of the contents, pressure, and temperature of the interior volume of the enclosure, and
wherein the input air has a temperature equal to less than 0° C., or a humidity equal to or less than 5 g of H₂O per kg of air, prior to entering the enclosure.

2. The CO₂ direct air capture apparatus of claim 1, further comprising a drying means located between the source of input air and the enclosure, whereby the drying means is configured to remove water from the input air prior to the input air entering the interior volume of the enclosure.

3. The CO₂ direct air capture apparatus of claim 1, wherein the CO₂ adsorbent bed comprises a zeolite, metal organic framework, covalent organic framework, silica, or alumina CO₂ adsorbent.

4. The CO₂ direct air capture apparatus of claim 1 wherein the vacuum source is further coupled to a second enclosure to collect and concentrate the CO₂.

5. The CO₂ direct air capture apparatus of claim 1, further comprising a fan capable of controlling or directing the flow of air or gas within the enclosure.

6. A method of CO₂ direct air capture, comprising:
a. flowing a source of input air into an interior volume of an enclosure containing a CO₂ adsorbent bed, wherein the input air has a temperature equal to or less than 0° C., or a humidity equal to or less than 5 g of H₂O per kg of air;
b. heating the CO₂ adsorbent bed and applying a vacuum source to the interior volume of the enclosure to permit extraction of the CO₂ from within the enclosure; and
c. equilibrating the pressure of the enclosure by permitting an influx of air or gas until the interior volume of the enclosure returns to about atmospheric pressure.

7. The method of claim 6, wherein the source of input air passes through a drying means prior to entering the enclosure.

8. The method of claim 6, wherein the vacuum source is applied prior to heating the CO₂ adsorbent bed, to permit extraction of non-CO₂ components of the input air from the interior volume of the enclosure prior to extracting the CO₂ from the adsorbent.

9. The method of claim 6, wherein the air or gas used to equilibrate the pressure in the enclosure passes through a drying means prior to entering the enclosure.

10. The method of claim 6, wherein the drying means is regenerated using air heated by the residual heat of the CO₂ adsorbent bed.

11. The method of claim 6, wherein the CO₂ adsorbent bed comprises a zeolite, metal organic framework, covalent organic framework, silica, or alumina CO₂ adsorbent material.

12. The method of claim 6, wherein the pressure of the interior volume of the enclosure when the CO₂ is extracted is between 0-0.25 atm.

13. The method of claim 6, wherein the pressure of the interior volume of the enclosure when the CO₂ is extracted is between 0-0.1 atm.

14. The method of claim 6, wherein the CO₂ adsorbent bed is heated to a temperature of about 75-275° C. during the extraction of CO₂.

15. The method of claim 6, wherein the process is configured to be continuously cycled to extract CO₂ from a continual source of input air.
